(19) United States
(12) Patent Application Publication
(10) Pub. No.: US 2006/0006587 A1
(43) Pub. Date: Jan. 12, 2006

(54) Formation of punched, blind holes through one wall of a double wall blow molded structure

(76) Inventor: Brent Schrader, Clinton, IA (US)

Correspondence Address: ST. ONGE STEWARD JOHNSTON & REENS, LLC, 986 BEDFORD STREET, STAMFORD, CT, 06905-5619, US

(21) Appl. No.: 11/224,271

(22) Filed: Sep. 12, 2005

Related U.S. Application Data
(62) Division of application No. 10/166,840, filed on Jun. 11, 2002.
(60) Provisional application No. 60/334,382, filed on Nov. 30, 2001.

(51) Int. Cl. B29C 49/00

(52) U.S. Cl. 264/531; 264/155

(57) ABSTRACT

A mold having a hole therein is provided, with a punch disposed within the hole in the mold surface. A portion of the punch extends out beyond the mold surface in an initial position such that the wall of the structure is initially formed therearound. The punch is movable to an activated position wherein the punch extends out beyond the mold to an extent greater than in the initial position. The punch is moved from the initial position to the activated position at a time interval after blow molding selected so that at least a portion of, and preferably a majority by volume of, the material forming the wall of the structure is in a molten state such that the cutting edge of the punch forms a hole through the wall of the structure along a line substantially perpendicular to a direction of travel of the punch.

### RELATED APPLICATIONS

This patent application is a divisional of currently pending U.S. patent application Ser. No. 10/166,840, filed Jun. 11, 2002, which claims the benefit of, under Title 35, United States Code, Section 119(e), U.S. Provisional Patent Application Ser. No. 60/334,382, filed Nov. 30, 2001.

### FIELD OF THE INVENTION

The present invention relates to an apparatus and method for forming holes in a plastic article, and more particularly to an apparatus and method for forming punched, blind holes through one wall of a double wall blow molded structure.

### BACKGROUND OF THE INVENTION

In the blow molding of double wall articles, it is often desirable to form a hole through one or both of the walls. Where such a hole is to be formed through both walls, which are usually separated by an air space, close dimensional control is obtainable, as shown in FIG. 1. Referring to this Figure, it is possible to mold sidewalls 10 and to pinch off a slug 11 in the center, and to subsequently remove slug 11 by punching it out. The resulting hole is precisely controlled as to cross-sectional and longitudinal dimensions by proper dimensioning of mold components. Likewise, enlarged cross sections 12 at the entry end of the main hole portion can also be precisely sized and shaped to form counterbores, or countersinks. Similarly, reliefs 13 for threaded nuts or snap-fitting barbs can be formed at the other end of the hole.

FIG. 2 shows in section the same molded hole configuration as does FIG. 1 with barbed attachment means 14 on a threaded insert 15 permanently installed into the molded hole. Note that the holes of FIGS. 1 and 2 are not necessarily restricted to round cross-sections. Alternately, they may be square or oval or hexagonal or any other shape appropriate to the application at hand.

The molding technique for hole forming shown in FIGS. 1 and 2 permits the economical production of precisely sized holes, with strong and accurately dimensioned sidewalls, in design situations where a hole is to be formed through both inner and outer walls of a double wall structure. However, a problem arises because it is often not desirable or even possible to have the hole extend through both walls. Sometimes styling considerations demand a smooth and unbroken exterior wall surface on either the inside or outside wall of a double wall structure. And in other instances the distance between the two walls is too great to permit forming a molded through hole of relatively small cross-section. In such situations, any hole in either wall, for the attachment of some sort of insert, must be a blind hole extending through one wall only of the double wall structure.

FIG. 3 illustrates a typical blind hole 16 formed in accordance with known methods. It should be noted that this hole 16 also can be controlled by mold dimensions as to cross-section and length and configuration of an enlarged area at the entry end. However, a problem often remains. The hole 16 of FIG. 3 cannot be enlarged at its inner end, because any significant enlargement of the mold cross-section in this area would fatally impede removal of the part from the mold. And yet, it is often essential to anchor an insert in the hole. Self-tapping screws may be used for attachment, but they generally do not hold well, because the preferred materials for most double wall molding, the olefin plastics, are both slippery and relatively soft, meaning that any thread will tend to loosen or strip. Therefore, the preferred attachment method, where one wall must remain unbroken, is by means of barbed engagement of the insert against the inner surface of a single wall which is drilled or punched to form a hole open to the space between the walls.

A hole formed in such fashion is shown in FIG. 4. Referring to this Figure, the wall of plastic as initially molded 17 (shown in phantom) drapes over a projection in the mold during the molding process to form a recess 18, or lies against a flat mold surface (not shown). After molding, a drill, boring tool, punch or the like 19 is activated, by conventional means, to remove the material in the cross-section 20 of what then becomes the hole. Although a hole may be formed in this fashion, this method suffers from a number of disadvantages of its own.

The wall thickness of the plastic in the punched cross-section is not always precisely controllable. Neither does the plane 21 of the punch always extend through the wall at a point of maximum thickness. Therefore, while the dimension of the molded sidewall portion 24 of the hole is precisely controllable, the portion 22 which is cut away or punched is not. And if the total side wall thickness 23 varies, then a barbed insert can not be made to seat properly on a consistent basis. If the thickness 23 is not sufficient, the barb will seat but with objectionable play; if the thickness is too large, the barb will not seat at all.

What is needed, therefore, is a method of forming a hole of a precise effective depth through a wall of plastic material, where the hole must be formed as a blind hole with forming tool access from one side only.

### SUMMARY OF THE INVENTION

Accordingly, it is an object of the present invention to provide an apparatus and method for forming holes in a plastic article which can be used to form blind holes through one wall of a double wall blow molded structure.

Another object of the present invention is to provide an apparatus and method for forming holes in a plastic article having the above characteristics and which can be used to form holes enlarged at their inner ends in order to accommodate barbed inserts.

A further object of the present invention is to provide an apparatus and method for forming holes in a plastic article having the above characteristics and which can be used to form holes open to the space between the walls.

Still another object of the present invention is to provide an apparatus and method for forming holes in a plastic article having the above characteristics and which can be used to form holes in which the wall thickness of the plastic in the punched cross-section is precisely controllable.

These and other objects of the present invention are achieved by provision of an apparatus and method for forming holes in a plastic article. An apparatus for forming a hole in a blow molded structure includes a mold at least partially defining a cavity for creating the blow-molded structure. The mold has a mold surface against which a wall of the blow molded structure is blown during blow molding. The mold also has a hole formed through the mold surface. A punch is disposed within the hole in the mold surface, a portion of the punch extending out beyond the mold surface in an initial position such that the wall of the blow molded structure is initially formed therearound. The punch is movable to an activated position wherein the punch extends out beyond the mold to an extent greater than in the initial position. The punch includes a cutting edge along the portion thereof which extends beyond the mold surface.

The punch is moved from the initial position to the activated position at a time interval after blow molding selected so that at least a portion of, and preferably a majority by volume of, the material forming the wall of the blow molded structure is in a molten state such that the cutting edge of the punch forms a hole through the wall of the blow molded structure along a line substantially perpendicular to a direction of travel of the punch from the initial position to the activated position.

Preferably, the blow-molded structure comprises a double wall blow molded structure. Also preferably, a shelf is formed by the punch surrounding the hole created thereby. Most preferably, the shape of the shelf is variable by varying a parameter selected from the group consisting of the shape of the cutting edge of the punch, the temperature of punch, the temperature of the mold surface, the speed of movement of the punch, the timing of movement of the punch, and combinations of these. Preferably, the time interval after blow molding when said punch is moved from the initial position to the activated position falls within a range from about 5 seconds to about 45 seconds, and most preferably within a range from about 20 seconds to about 30 seconds.

In another aspect, a method for forming a hole in a blow molded structure is provided. A mold at least partially defining a cavity for creating the blow molded structure is provided, the mold having a mold surface against which a wall of the blow molded structure is blown during blow molding. The mold also has a hole formed through the mold surface. A punch is disposed within the hole in the mold surface of the mold, the punch having a cutting edge along the portion thereof which extends beyond the mold surface. A portion of the punch is extended out beyond the mold surface in an initial position such that the wall of the blow molded structure is initially formed therearound during blow molding, and the structure is then blow molded. After waiting for a time interval after blow molding, the time interval selected so that at least a portion of, and preferably a majority by volume of, the material forming the wall of the blow molded structure remains in a molten state, the punch is moved to an activated position wherein the punch extends out beyond the mold to an extent greater than in the initial position. A hole is thus formed through the wall of the blow molded structure with the cutting edge of the punch along a line substantially perpendicular to a direction of travel of the punch from the initial position to the activated position.

Preferably, the blow-molded structure comprises a double wall blow molded structure. Also preferably, a shelf is formed by the punch surrounding the hole created thereby during the step where the hole is formed. Most preferably, a shape of the shelf is variable by varying a parameter selected from the group consisting of the shape of the cutting edge of the punch, the temperature of punch, the temperature of the mold surface, the speed of movement of the punch, the timing of movement of the punch, and combinations of these. Preferably, the time interval after blow molding before moving the punch to the activated position falls within a range from about 5 seconds to about 45 seconds, and most preferably within a range from about 20 seconds to about 30 seconds.

The invention and its particular features and advantages will become more apparent from the following detailed description considered with reference to the accompanying drawings.

### BRIEF DESCRIPTION OF THE DRAWINGS

FIG. 1 is a partially cross-sectional side view of a known hole configuration in which the hole extends through both walls of a double wall blow molded structure;

FIG. 2 is a partially cross-sectional side view of the known hole configuration shown in FIG. 1 with a barbed insert member inserted therein;

FIG. 3 is a partially cross-sectional side view of a known hole configuration in which the hole is formed in only one wall of a double wall blow molded structure;

FIG. 4 is a partially cross-sectional side view illustrating a known method for forming a hole in which the hole extends through only one wall of a double wall blow molded structure;

FIG. 5 is a partially cross-sectional side view illustrating a method for forming a hole in which the hole extends through only one wall of a double wall blow molded structure in accordance with one embodiment of the present invention; and

FIG. 6 is a partially cross-sectional side view an embodiment of a hole in which the hole extends through only one wall of a double wall blow molded structure formed in accordance with the method illustrated in FIG. 5.

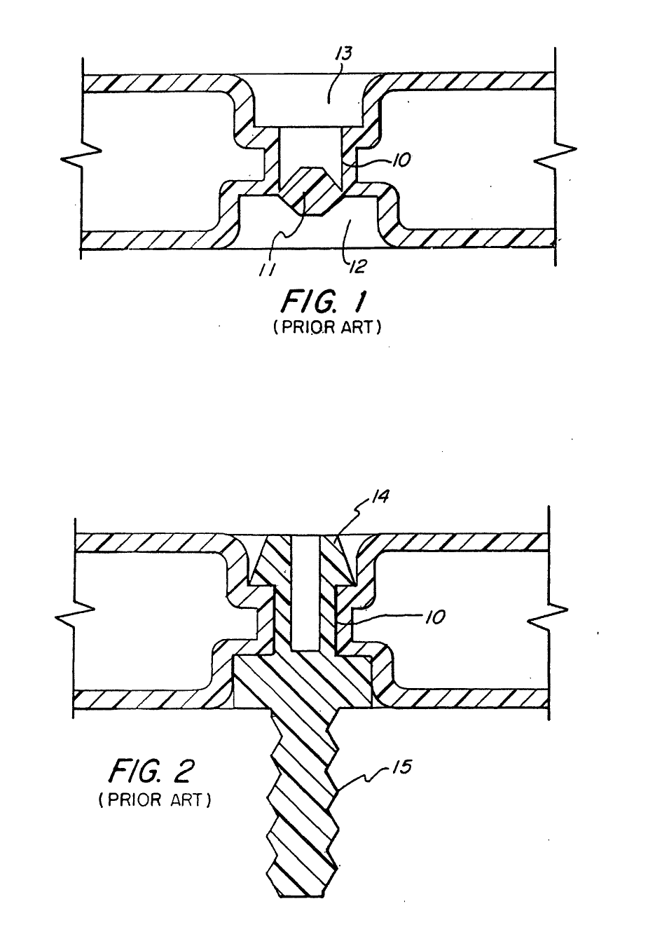

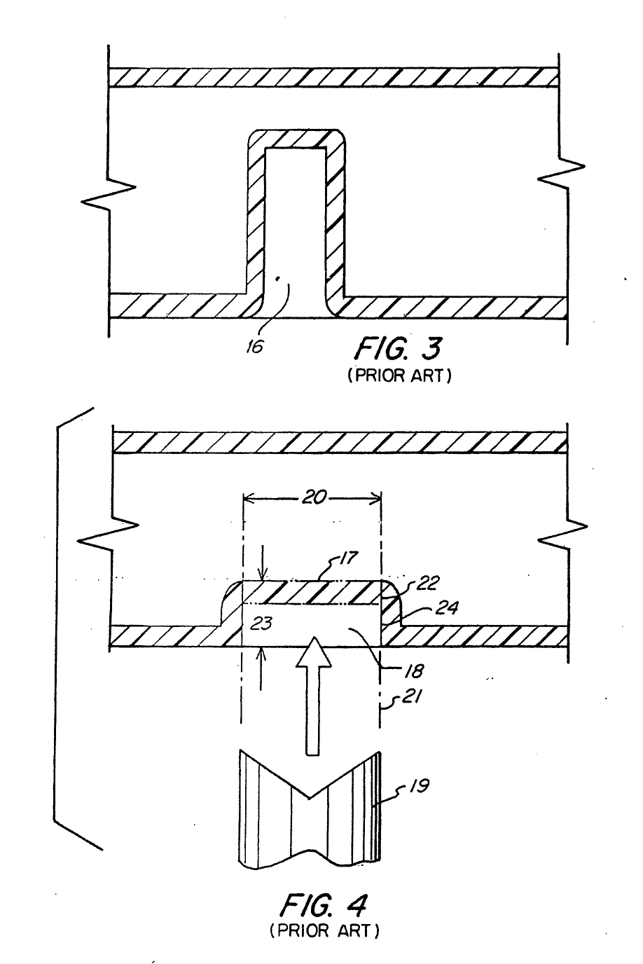

### DETAILED DESCRIPTION OF AN EMBODIMENT OF THE INVENTION

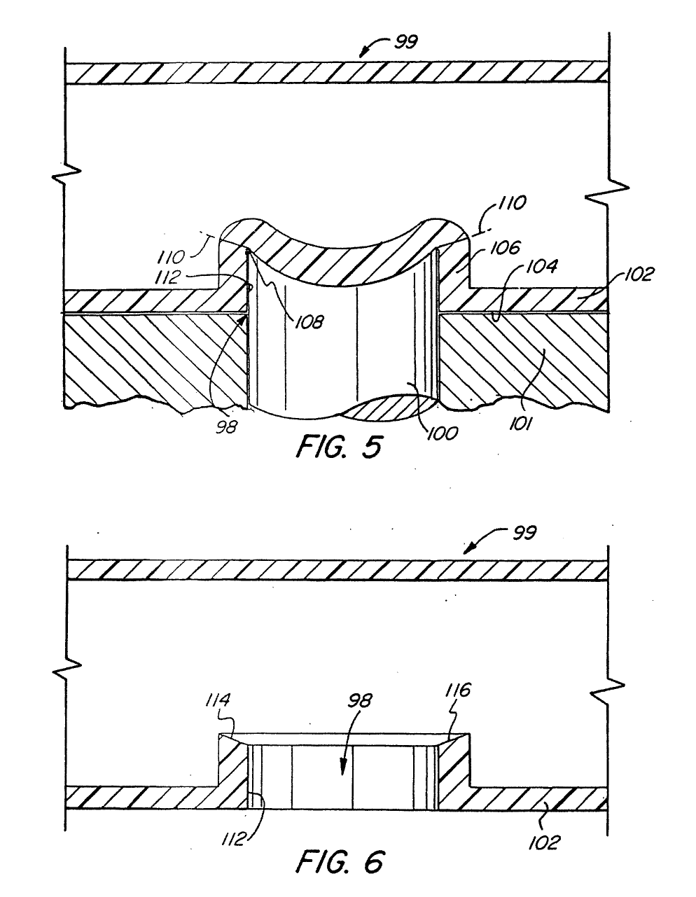

Referring to FIGS. 5 and 6, a hole 98 and an apparatus and method for forming hole 98 in a double wall blow molded structure 99 in accordance with the present invention are shown. FIG. 5 shows a shaped punch 100 in position to pierce a molded wall 102 of plastic material. As shown in the Figure, while the object is being blow-molded, a portion of punch 100 extends out beyond the mold surfaces 101, and wall 102 is initially molded therearound. At the instant that wall 102 is blown against punch 100 and its surrounding mold surfaces 101, the material is hot and molten. The skin 104 of the material, perhaps 0.002 in. to 0.004 in. thick, freezes almost instantly against the cooler mold 101 and punch 100. In so doing, this skin 104 forms a heat insulator between the mold 101 and punch 100 and the molten interior plastic 106 adjoining skin 104. This remaining interior plastic material 106 continues to cool, but progressively more slowly as the thickening skin 104 insulates it from the cool mold 101 and punch 100.

Punch 100 includes a cutting edge 108 surrounding a periphery thereof. While the precise configuration of the cutting edge 108 may be varied, it has been found that a punch 100 having a concave cutting edge 108 provides desirable results.

To form hole 98 of the present invention, punch 100 is activated early in the molding cycle, when most of the plastic wall 102 remains molten or almost so. Doing so shears the frozen plastic skin 104 immediately adjacent to cutting edge 108 of punch 100. However, this break does not then continue in a direction parallel to the stroke of punch 100. Rather, the break travels outwardly, generally parallel to the face of punch 100, generally along line 110, thereby creating a precisely controllable hole sidewall dimension consisting of molded sidewall 112 plus an increment equal to the thickness of the sheared skin 104. Furthermore, as best seen in FIG. 6, the back edge 114 of hole 98 is almost perpendicular to the hole sidewall 1 12, thereby providing a useful shelf 116 behind which a barb or other interference configuration can seat itself.

It should be understood by those skilled in the art that the precise time during the molding process which punch 100 is activated will vary depending upon a number of considerations, including the material used for creating sidewall 102, the temperature of the material used for creating sidewall 102, the temperature of mold 101 and punch 100, the thickness of sidewall 102, etc. However, it is to be understood that punch 100 is activated while at least some, and preferably a majority by volume, of the material forming sidewall 102 is in a molten state. For purposes of illustration, and not limitation, it has been found that in a typical situation wherein a hole having an approximate diameter of 0.375 in. is to be formed in an olefin plastic wall having an approximate thickness of 0.090 in. and a temperature of 350° F. using a convex punch having a configuration similar to that shown in FIG. 5 and operating at normal room temperature, the punch should preferably be activated approximately 5 to 45 seconds after molding. During this time period, it has been found that the thickness of the skin of frozen material is approximately 0.008 in. to 0.010 in. Even more optimal results have been found to result when the punch is activated approximately 20 to 30 seconds after molding, when the thickness of the skin of frozen material is approximately 0.004 in. to 0.007 in.

In addition, it should be understood that the geometry of shelf 1 16 can be varied by changing the geometry of the face of punch 100, by varying the temperature of punch 100 and its surrounding mold surfaces 101, and by altering the speed or timing of punch travel.

The present invention, therefore, provides an apparatus and method for forming holes in a plastic article which can be used to form blind holes through one wall of a double wall blow molded structure, which can be used to form holes enlarged at their inner ends in order to accommodate barbed inserts, which can be used to form holes open to the space between the walls, and which can be used to form holes in which the wall thickness of the plastic in the punched cross-section is precisely controllable.

Although the present invention has been described with reference to a particular arrangement of parts, features and the like, it should be understood that the invention is in no way limited to the precise embodiments illustrated, and the particular arrangement of parts and features herein described are not intended to exhaust all possible arrangements of parts and features. For example, various ratios of depth to cross-section are obtainable, interference surfaces other than a barb can be utilized on the insert to be installed, and other types of inserts, such as “pop” rivets, may be used. Indeed many other modifications and variations will be ascertainable to those of skill in the art.

What is claimed is:

1. A method for forming a hole in a blow molded structure, said method comprising the steps of:
providing a mold at least partially defining a cavity for creating the blow molded structure, the mold having a mold surface against which a wall of the blow molded structure is blown during blow molding, the mold also having a hole formed through the mold surface;
providing a punch disposed within the hole in the mold surface of the mold, the punch having a cutting edge along the portion thereof which extends beyond the mold surface;
extending a portion of the punch out beyond the mold surface in an initial position such that the wall of the blow molded structure is initially formed therearound during blow molding;
blow molding the blow molded structure;
waiting for a time interval after blow molding selected so that at least a portion of the material forming the wall of the blow molded structure remains in a molten state;
moving the punch to an activated position wherein the punch extends out beyond the mold to an extent greater than in the initial position; and
forming a hole through the wall of the blow molded structure with the cutting edge of the punch along a line substantially perpendicular to a direction of travel of the punch from the initial position to the activated position.

2. The method of claim 11 wherein said waiting step comprises the step of waiting for a time interval after blow molding selected so that a majority by volume of the material forming the wall of the blow molded structure remains in a molten state.

3. The method of claim 1 wherein the blow-molded structure comprises a double wall blow molded structure.

4. The method of claim 1 wherein a shelf is formed by the punch surrounding the hole created thereby during said forming step.

5. The method of claim 4 wherein the shelf is generally frustoconical in shape tapering inwardly toward the hole such that a portion of the shelf having a greatest diameter is located further from the mold surface than a portion of the shelf having a smallest diameter.

6. The method of claim 4 wherein a shape of the shelf is variable by varying a parameter selected from the group consisting of the shape of the cutting edge of the punch, the temperature of punch, the temperature of the mold surface, the speed of movement of the punch, the timing of movement of the punch, and combinations of these.

7. The method of claim 1 wherein the time interval after blow molding in said waiting step falls within a range from about 5 seconds to about 45 seconds.

8. The method of claim 7 wherein the time interval after blow molding in said waiting step falls within a range from about 20 seconds to about 30 seconds.

9. A method for forming a hole in a blow molded structure, said method comprising the steps of:
providing a mold at least partially defining a cavity for creating the blow molded structure, the mold having a mold surface against which a wall of the blow molded structure is blown during blow molding, the mold also having a hole formed through the mold surface;
providing a punch disposed within the hole in the mold surface of the mold, the punch having a cutting edge along the portion thereof which extends beyond the mold surface;
extending a portion of the punch out beyond the mold surface in an initial position such that the wall of the blow molded structure is initially formed therearound during blow molding;
blow molding the blow molded structure;
moving the punch to an activated position wherein the punch extends out beyond the mold to an extent greater than in the initial position;
forming a hole through the wall of the blow molded structure with the cutting edge of the punch; and
forming a shelf around the hole, the shelf being generally frustoconical in shape tapering inwardly toward the hole such that a portion of the shelf having a greatest diameter is located further from the mold surface than a portion of the shelf having a smallest diameter.

10. The method of claim 9 further comprising the step of waiting for a time interval after said blow molding step and before said moving step, the time interval selected so that at least a portion of the material forming the wall of the blow molded structure remains in a molten state.

11. The method of claim 10 wherein said waiting step comprises the step of waiting after said blow molding step and before said moving step, the time interval selected so that a majority by volume of the material forming the wall of the blow molded structure remains in a molten state.

12. The method of claim 9 wherein the blow-molded structure comprises a double wall blow molded structure.

13. The method of claim 9 wherein a shape of the shelf is variable by varying a parameter selected from the group consisting of the shape of the cutting edge of the punch, the temperature of punch, the temperature of the mold surface, the speed of movement of the punch, the timing of movement of the punch, and combinations of these.

14. The method of claim 9 wherein the time interval after blow molding in said waiting step falls within a range from about 5 seconds to about 45 seconds.

15. The method of claim 14 wherein the time interval after blow molding in said waiting step falls within a range from about 20 seconds to about 30 seconds.
